(19) United States
(12) Patent Application Publication
(10) Pub. No.: US 2013/0162569 A1
(43) Pub. Date: Jun. 27, 2013

(54) DEVICE, METHOD, AND COMPUTER-READABLE RECORDING MEDIUM

(71) Applicant: KYOCERA CORPORATION, Kyoto (JP)

(72) Inventor: Tomohiro Sudo, Kyoto (JP)

(73) Assignee: KYOCERA CORPORATION, Kyoto (JP)

(21) Appl. No.: 13/720,464

(22) Filed: Dec. 19, 2012

(30) Foreign Application Priority Data
Dec. 21, 2011 (JP) 2011-279835

(51) Int. Cl. G06F 3/0484

(52) U.S. Cl. CPC G06F 3/04845
USPC 345/173

(57) ABSTRACT

An object of the present invention is to provide a device, a method, and a computer-readable recording medium, all of which improve the operability for enlarging or reducing an image. A controller sets a scale factor for enlarging or reducing a display image displayed on a touch-screen display, in response to detecting a touch to a plurality of points on the touch-screen display. The controller enlarges or reduces the display image, based on a gesture after touching the plurality of points (multi-touch gesture), and the scale factor thus set.

This application is based on and claims the benefit of priority from Japanese Patent Application No. 2011-279835 filed on 21 Dec. 2011, the content of which is incorporated herein by reference.

### BACKGROUND OF THE INVENTION

1. Field of the Invention

The present invention relates to a device, a method, and a recording medium. In particular, the present invention relates to a device having a touch-screen display, a method for controlling the device, and a computer-readable recording medium storing a program for controlling the device.

2. Related Art

A device including a touch-screen display has been known. Examples of the device including the touch-screen display include, for example, a smartphone and a tablet. The device including the touch-screen display detects gestures of a finger or a stylus pen via the touch-screen display. The device including the touch-screen display is operated in accordance with the gestures thus detected. Examples of operations in accordance with detected gestures are disclosed in, for example, PCT International Publication, No. WO 2008/086302.

Basic operations of a device including a touch-screen display are implemented by an OS (Operating System) such as Android (registered trademark), BlackBerry (registered trademark) OS, Symbian (registered trademark) OS, iOS, Windows (registered trademark) Phone, etc. installed in the device.

### SUMMARY OF THE INVENTION

Incidentally, in the above device, an image displayed on the touch-screen display is reduced when a pinch-in is performed, which is a gesture of a plurality of fingers moving in mutually approaching directions while touching the touch screen display. In the above device, the image displayed on the touch-screen display is enlarged when a pinch-out is performed, which is a gesture of a plurality of fingers moving in mutually separating directions while touching the touch screen display. However, since the scale factors for a pinch-in and a pinch-out are determined based on the user's gesture of the plurality of fingers, it has been required to improve the operability through simpler operations.

An object of the present invention is to provide a device, a method, and a computer-readable recording medium, all of which improve the operability for enlarging or reducing an image.

According to an aspect, a device includes: a touch-screen display that detects a touch to a plurality of points; and a controller that changes a scale factor for enlarging or reducing an image displayed on the touch-screen display in response to the touch to the plurality of points, and displays the image by enlarging or reducing the image, based on the scale factor thus changed.

According to another aspect, a method for enlarging or reducing an image displayed on a touch-screen display in a device including the touch-screen display is provided. The method including the steps of: detecting a touch to a plurality of points on the touch-screen display by a controller provided to the device; changing a scale factor for enlarging or reducing an image displayed on the touch-screen display, in response to detecting the touch to the plurality of points, by the controller; and enlarging or reducing the image, based on the scale factor.

According to another aspect, a computer-readable recording medium that stores a program for enlarging or reducing an image displayed on a touch-screen display in a device including the touch-screen display is provided. The program causing the device to execute the steps of: detecting a touch to a plurality of points on the touch-screen display setting a scale factor for enlarging or reducing an image displayed on the touch-screen display, in response to detecting the touch to the plurality of points; and enlarging or reducing the image, based on the scale factor.

### BRIEF DESCRIPTION OF THE DRAWINGS

FIG. 1 is a perspective view showing an external appearance of a smartphone according to an embodiment;

FIG. 2 is a front view showing the external appearance of the smartphone according to the embodiment;

FIG. 3 is rear view showing the external appearance of the smartphone according to the embodiment;

FIG. 4 is a diagram showing an example of a home screen;

FIG. 5 is a block diagram showing functions of the smartphone according to the embodiment;

FIG. 6 is a screen transition diagram showing processing of enlarging an image displayed on a touch-screen display according to the embodiment;

FIG. 7 is a screen transition diagram showing processing of setting a scale factor for enlarging an image displayed on the touch-screen display according to the embodiment; and

FIG. 8 is a flowchart showing a flow of processing for enlarging an image displayed on the touch-screen display.

### DETAILED DESCRIPTION OF THE INVENTION

An embodiment for carrying out the present invention is described in detail with reference to the drawings. A smartphone is hereinafter described as an example of a device including a touch-screen display.

### Embodiment

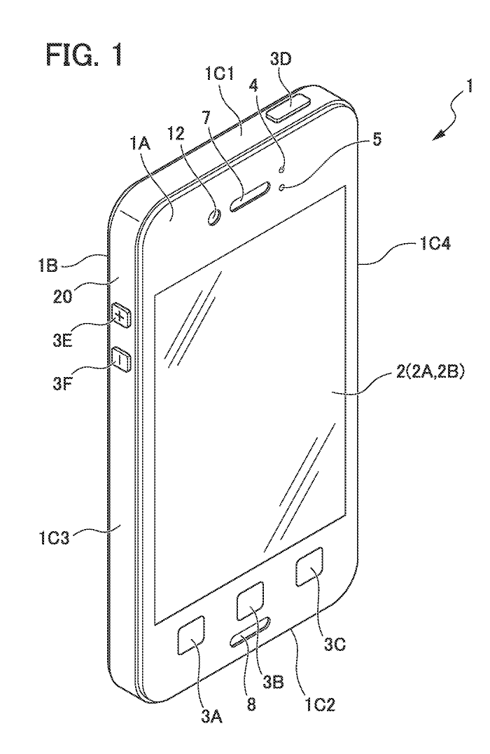

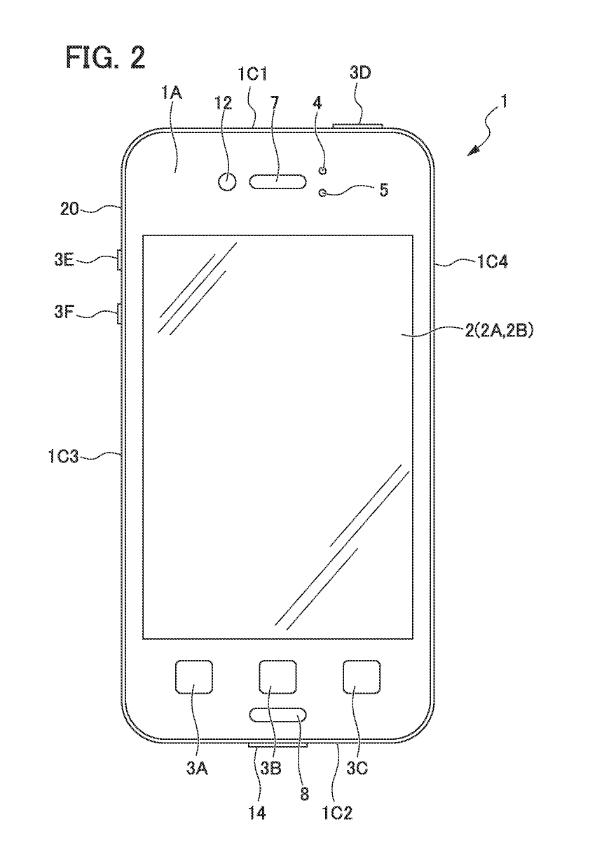

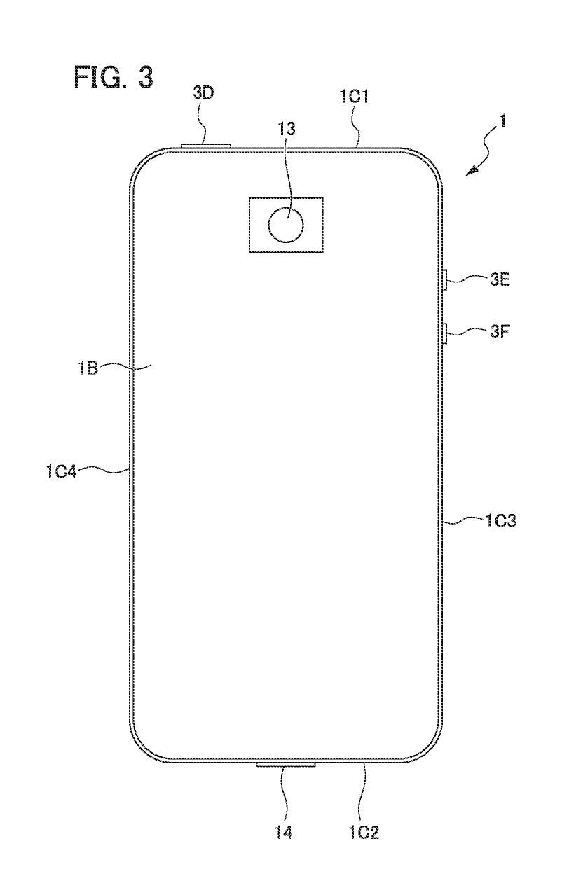

Descriptions are provided for an external appearance of a smartphone 1 according to the embodiment with reference to FIGS. 1 to 3. As shown in FIGS. 1 to 3, the smartphone 1 has a housing 20. The housing 20 has a front face 1A, a back face 1B, and side faces 1C1 to 1C4. The front face 1A is a front face of the housing 20. The back face 1B is a back face of the housing 20. The side faces 1C1 to 1C4 are side faces that connect the front face 1A and the back face 1B. In the following descriptions, the side faces 1C1 to 1C4 may be collectively referred to as a side face 1C without specifying which face.

On the front face 1A, the smartphone 1 has a touch-screen display 2, buttons 3A to 3C, an illuminance sensor 4, a proximity sensor 5, a receiver 7, a microphone 8, and a camera 12. The smartphone 1 has a camera 13 in the back face 1B. The smartphone 1 has buttons 3D to 3F and an external interface 14 in the side face 1C. In the following descriptions, the buttons 3A to 3F may be collectively referred to as a button 3 without specifying which button.

The touch-screen display 2 has a display 2A and a touch screen 2B. The display 2A includes a display device such as a liquid crystal display, an organic electro-luminescence panel, or an inorganic electro-luminescence panel. The display 2A displays characters, images, symbols, graphics or the like.

The touch screen 2B detects a touch by a finger, a stylus pen or the like to the touch-screen display 2. The touch screen 2B detects a position where a plurality of fingers, the stylus pen or the like touch the touch-screen display 2.

A detection method for the touch screen 2B may be any method such as a capacitive sensing method, a resistor film method, a surface acoustic wave method (or an ultrasonic sensing method), an infrared ray method, and an electromagnetic induction method. In the following, for the purpose of simplifying descriptions, the fingers, the stylus pen or the like may be simply referred to as a “finger”, a touch by which to the touch-screen display 2 is detected by the touch screen 2B.

The smartphone 1 distinguishes a type of a gesture, based on a touch(s), a touched position(s), a touching period of time, or a touching number of times, detected by the touch screen 2B. The gesture is an operation that is performed on the touch-screen display 2. Gestures that are distinguished by the smartphone 1 include a touch, a long touch, a release, a swipe, a tap, a double tap, a long tap, a drag, a flick, a pinch-in, a pinch-out, and the like.

The touch is a gesture of a single touch. More specifically, the touch is a gesture of a finger touching (for example, a surface of) the touch-screen display 2. The smartphone 1 distinguishes the gesture of a finger touching the touch-screen display 2 as a touch. The long touch is a gesture of a finger touching the touch-screen display 2 for more than a certain period of time. The smartphone 1 distinguishes the gesture of a finger touching the touch-screen display 2 for more than a certain period of time as a long touch.

The release is a gesture of a finger being released from the touch-screen display 2. The smartphone 1 distinguishes the gesture of a finger being released from the touch-screen display 2 as a release. The swipe is a gesture of a finger moving while touching the touch-screen display 2. The smartphone 1 distinguishes the gesture of a finger moving while touching the touch-screen display 2 as a swipe.

The tap is a consecutive gesture of touch and release. The smartphone 1 distinguishes the consecutive gesture of touch and release as a tap. The double tap is a gesture of repeating a consecutive gesture of touch and release two times. The smartphone 1 distinguishes the gesture of repeating a consecutive gesture of touch and release two times as a double tap.

The long tap is a consecutive gesture of a long touch and release. The smartphone 1 distinguishes the consecutive gesture of a long touch and release as a long tap. The drag is a gesture of swiping from a starting point where a movable object is displayed. The smartphone 1 distinguishes the gesture of swiping from a starting point where a movable object is displayed as a drag.

The flick is a consecutive gesture of touch and release of a finger moving at a high-speed in one direction. The smartphone 1 distinguishes the gesture of touch and release of a finger moving at a high-speed in one direction as a flick. The flick includes: an upward flick of a finger moving in an upward direction on the screen; a downward flick of a finger moving in a downward direction on the screen; a rightward flick of a finger moving in a rightward direction on the screen; a leftward flick of a finger moving in a leftward direction on the screen; and the like.

The pinch-in is a gesture of a plurality of fingers swiping in mutually approaching directions. The smartphone 1 distinguishes the gesture of a plurality of fingers swiping in mutually approaching directions as a pinch-in. The pinch-out is a gesture of a plurality of fingers swiping in mutually receding directions. The smartphone 1 distinguishes the gesture of a plurality of fingers swiping in mutually receding directions as a pinch-out.

The smartphone 1 is operated in accordance with these gestures that are distinguished via the touch screen 2B. Therefore, intuitive and easy-to-use operability is achieved for a user. An operation, which is performed by the smartphone 1 in accordance with a gesture thus distinguished, is different depending on a screen that is displayed on the touch-screen display 2.

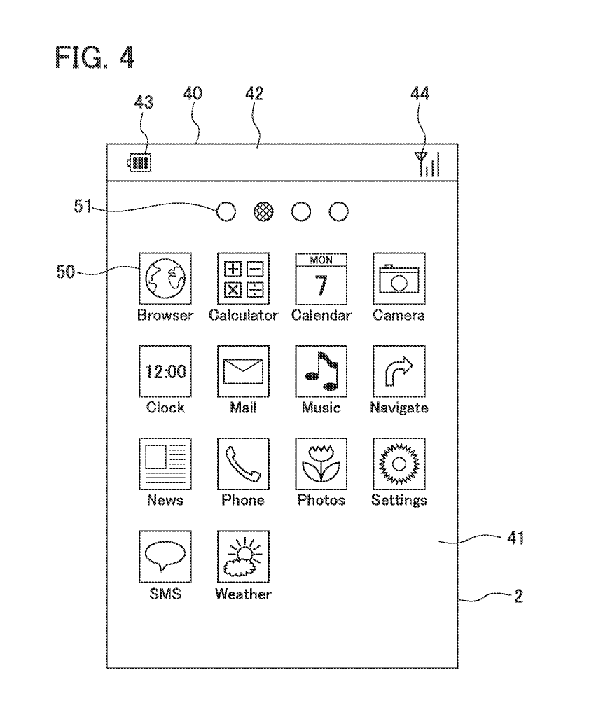

An example of a screen displayed on the display 2A is described with reference to FIG. 4. FIG. 4 shows an example of a home screen. The home screen may be called a desktop or an idle screen. The home screen is displayed on the display 2A. The home screen is a screen for allowing the user to select which application to be executed among applications installed in the smartphone 1. When an application is selected in the home screen, the smartphone 1 executes the application in the foreground. The screen of the application executed in the foreground is displayed on the display 2A.

The smartphone 1 can arrange icons in the home screen. A plurality of icons 50 are arranged in the home screen 40 shown in FIG. 4. The icons 50 are previously associated with the applications installed in the smartphone 1, respectively. When the smartphone 1 detects a gesture on an icon 50, an application associated with the icon 50 is executed. For example, when the smartphone 1 detects a tap on an icon 50 associated with a mail application, the mail application is executed. Here, for example, the smartphone 1 interprets the gesture on a position (area), which corresponds to a display position (area) of the icon 50 on the touch-screen display 2, as an instruction to execute an application associated with the icon 50.

The icon 50 includes an image and a character string. The icon 50 may include a symbol or graphics in place of the image. The icon 50 may not include any one of the image or the character string. The icons 50 are arranged in accordance with a predetermined rule. A wall paper 41 is displayed behind the icons 50. The wall paper may also be called a photo screen or a back screen. The smartphone 1 can use an arbitrary image as the wall paper 41. An arbitrary image is determined as the wall paper 41, for example, in accordance with the setting by the user.

The smartphone 1 can increase and decrease the number of home screens. The smartphone 1 determines the number of home screens, for example, in accordance with the setting by the user. Even in a case in which there are a plurality of home screens, the smartphone 1 selects a single home screen from the plurality of home screens, and displays the single home screen on the display 2A.

The smartphone 1 displays one or more locators on the home screen. The number of the locators coincides with the number of the home screens. The locator indicates the position of the currently displayed home screen. The locator corresponding to the currently displayed home screen is displayed in a manner different from the other locators.

Four locators 51 are displayed in the example shown in FIG. 4. This indicates that there are four home screens 40. In the example shown in FIG. 4, the second symbol (locator) from the left is displayed in a manner different from the other symbols (locators). This indicates that the second home screen from the left is currently displayed.

When the smartphone 1 detects a particular gesture while displaying the home screen, the home screen displayed on the display 2A is switched. For example, when the smartphone 1 detects a rightward flick, the home screen displayed on the display 2A is switched over to a next home screen to the left. When the smartphone 1 detects a leftward flick, the home screen displayed on the display 2A is switched over to a next home screen to the right.

An area 42 is provided at the top edge of the display 2A. A remaining-level mark 43 indicating a remaining level of the rechargeable battery, and a radio wave level mark 44 indicating field intensity of radio waves for communication are displayed in the area 42. In the area 42, the smartphone 1 may display current time, weather information, active applications, a type of communication system, a telephone status, a device mode, events occurred to the device, etc. In this way, the area 42 is used for making various notifications to the user. The area 42 may be provided as another screen separate from the home screen 40. The position of providing the area 42 is not limited to the top edge of the display 2A.

The home screen 40 shown in FIG. 4 is an example, and shapes of various elements, layouts of various elements, the number of home screens 40, and the manner of various operations on the home screen 40 may not be as described in the above descriptions.

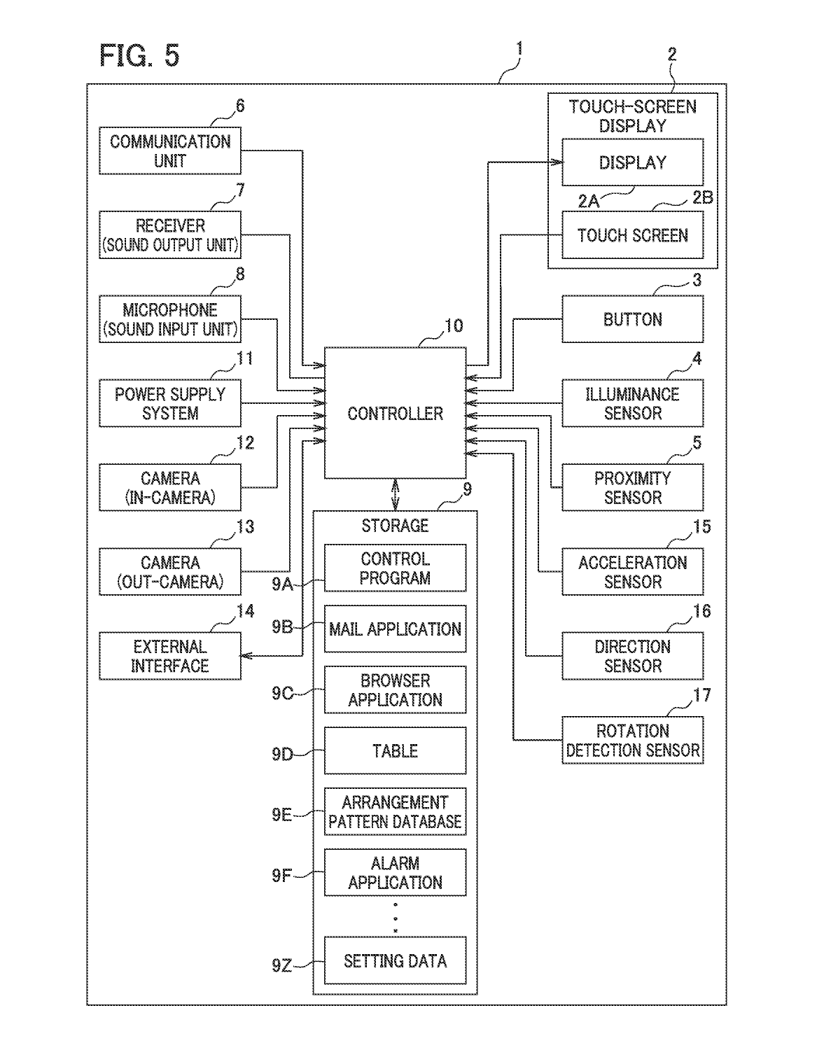

FIG. 5 is a block diagram showing a configuration of the smartphone 1. The smartphone 1 has the touch-screen display 2, the button 3, the illuminance sensor 4, the proximity sensor 5, a communication unit 6, the receiver 7, the microphone 8, a storage 9, a controller 10, cameras 12 and 13, an external interface 14, an acceleration sensor 15, a direction sensor 16, and a rotation detection sensor 17.

As described above, the touch-screen display 2 has the display 2A and the touch screen 2B. The display 2A displays characters, images, symbols, graphics or the like. The smartphone 1 detects a gesture via the touch screen 2B.

The button 3 is operated by the user. The button 3 has the buttons 3A to 3F. The controller 10 collaborates with the button 3 to detect an operation of the button. The operation of the button is, for example, a click, a double click, a push, and a multi-push.

For example, the buttons 3A to 3C are a home button, a back button or a menu button. For example, the button 3D is a power on/off button of the smartphone 1. The button 3D may also serve as a sleep/wake-up button. For example, the buttons 3E and 3F are volume buttons.

The illuminance sensor 4 detects illuminance. For example, the illuminance is intensity, brightness, brilliance, etc. of light. For example, the illuminance sensor 4 is used for adjusting the brilliance of the display 2A.

The proximity sensor 5 detects presence of a proximate object in a contactless manner. The proximity sensor 5 detects, for example, a face being brought close to the touch-screen display 2.

The communication unit 6 performs wireless communication. Communication methods implemented by the communication unit 6 are wireless communication standards. For example, the wireless communication standards include cellular phone communication standards such as 2G, 3G and 4G. For example, the cellular phone communication standards include LTE (Long Term Evolution), W-CDMA, CDMA2000, PDC, GSM (registered trademark), PHS (Personal Handy-phone System), etc. For example, the wireless communication standards include WiMAX (Worldwide Interoperability for Microwave Access), IEEE 802.11, Bluetooth (registered trademark), IrDA, NFC (Near Field Communication), etc. Communication unit 6 may support one or more of the communication standards described above.

When a sound signal is transmitted from the controller 10, the receiver 7 outputs the sound signal as sound. The microphone 8 converts sound such as the user's voice into a sound signal, and transmits the sound signal to the controller 10. The smartphone 1 may further have a speaker(s) in addition to the receiver 7. The smartphone 1 may further have a speaker(s) in place of the receiver 7.

The storage 9 stores programs and data. The storage 9 is also utilized as a working area for temporarily storing processing results of the controller 10. The storage 9 may include an arbitrary storage device such as a semi-conductor storage device and a magnetic storage device. The storage 9 may include several types of storage devices. The storage 9 may include combination of a portable storage medium such as a memory card with a reader for the storage medium.

The programs stored in the storage 9 include: applications that are executed in the foreground or the background; and a control program that assists operations of the applications. For example, an application causes the display 2A to display a predetermined screen, and causes the controller 10 to execute processing in accordance with a gesture detected by the touch screen 2B. The control program is, for example, an OS. The applications and the control program may be installed in the storage 9 via wireless communication by the communication unit 6 or via a storage medium.

The storage 9 stores, for example, a control program 9A, a mail application 9B, a browser application 9C, and setting data 9Z. The mail application 9B provides electric mail functions of creating, transmitting, receiving and displaying electric mail. The browser application 9C provides a web browsing function of displaying web pages. A table 9D stores various tables such as a key assignment table. An arrangement pattern database 9E stores patterns of arrangement such as arrangement of icons displayed on the display 2A. The setting data 9Z provides various set-up functions regarding operations of the smartphone 1.

The control program 9A provides functions regarding a variety of control for operating the smartphone 1. For example, the control program 9A implements a telephone call function by controlling the communication unit 6, the receiver 7, the microphone 8, etc. The functions provided by the control program 9A include functions of executing a variety of control such as changing the information displayed on the display 2A in accordance with a gesture detected via the touch screen 2B. The functions provided by the control program 9A may be utilized in combination with functions provided by other programs such as the mail application 9B.

The controller 10 is, for example, a CPU (Central Processing Unit). The controller 10 may be an integrated circuit such as an SoC (System-on-a-chip) that integrates other constituent elements such as the communication unit 6. The controller 10 comprehensively controls the operations of the smartphone 1 to implement various functions.

More specifically, the controller 10 implements various functions by referring to data stored in the storage 9 as necessary, executing instructions included in a program stored in the storage 9, and controlling the display 2A, the communication unit 6, etc. The controller 10 may change the control in accordance with a result of detection by various detecting units such as the touch screen 2B, the button 3 and the acceleration sensor 15.

For example, the controller 10 executes the control program 9A to execute a variety of control such as changing the information displayed on the display 2A in accordance with a gesture detected via the touch screen 2B.

The camera 12 is an in-camera that photographs an object from a side of the front face 1A. The camera 13 is an out-camera that photographs an object from a side of the back face 1B.

The external interface 14 is a terminal, to which another device is connected. The external interface 14 may be a universal terminal such as USB (Universal Serial Bus), HDMI (High-Definition Multimedia Interface), Light Peak (Thunderbolt), and an earpiece-microphone connector. The external interface 14 may be a terminal designed for exclusive use, such as a Dock connector. A device that is connected to the external interface 14 includes, for example, an external storage, a speaker, and a communication device.

The acceleration sensor 15 detects a direction and level of acceleration that acts on the smartphone 1. The direction sensor 16 detects an orientation of geomagnetism. The rotation detection sensor 17 detects rotation of the smartphone 1. Results of such detection by the acceleration sensor 15, the direction sensor 16 and the rotation detection sensor 17 are utilized in combination to detect change in the position and posture of the smartphone 1.

The smartphone 1 as thus constituted can improve the operability by enlarging or reducing an image displayed on the touch-screen display 2 through simple operations. An image displayed on the touch-screen display 2 is an image displayed in the entire display area of the touch-screen display 2. In the following, an image displayed on the touch-screen display 2 is also referred to as a display image. Descriptions are hereinafter provided for specific processing.

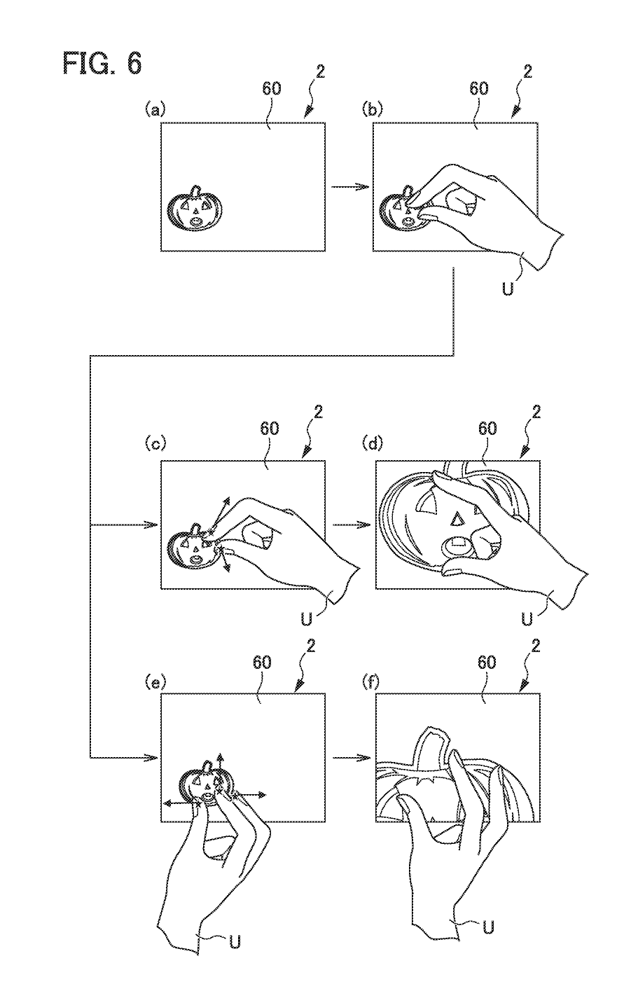

FIGS. 6(a) to 6(f) are screen transition diagrams showing processing of enlarging an image displayed on the touch-screen display 2. FIG. 6(a) is a diagram showing a display image 60. As described above, the display image 60 is an image displayed in the entire display area of the touch-screen display 2.

The controller 10 changes a scale factor for enlarging or reducing the display image 60 displayed on the touch-screen display 2, in response to detecting a touch to a plurality of points on the touch-screen display 2. The controller 10 enlarges or reduces the display image 60, based on a gesture after touching the plurality of points (multi-touch gesture), and based on the scale factor thus changed. In other words, when a gesture for enlarging or reducing the display image 60 is detected, the controller 10 enlarges or reduces the display image 60, based on the scale factor thus changed.

More specifically, in a state shown in FIG. 6(a), the controller 10 detects a touch to a plurality of points on the touch-screen display 2 (multi-touch) as shown in FIG. 6(b).

When the controller 10 detects the touch to the plurality of points on the touch-screen display 2, the controller 10 enlarges or reduces the display image 60, based on a relative distance between two points (of pinch-in or pinch-out) among the plurality of points touched on the touch-screen display 2, and based on the scale factor thus changed. In other words, the controller 10 changes an enlargement factor and a reduction factor of the display image 60, in relation to an amount of change in the relative distance between the two points thus touched.

For example, as shown in FIGS. 6(c) and 6(d), when the controller 10 detects a touch to two points on the touch-screen display 2, the controller 10 enlarges the display image 60, based on the relative distance between the two points, and based on the scale factor thus changed.

Alternatively, as shown in FIGS. 6(e) and 6(f), when the controller 10 detects a touch to three points on the touch-screen display 2, the controller 10 enlarges the display image 60, based on a relative distance between two of the three points (for example, between two points touched by a finger a and a finger b, respectively), and based on the scale factor thus changed. In this case, the controller 10 does not consider movement of a finger c. The controller 10 enlarges the display image 60, based on a relative distance between two of the three points, the two points having moved for the longest distance after firstly detecting the touch, and based on the scale factor.

In this way, the smartphone 1 enlarges or reduces the display image 60, based on a relative distance between two points among the plurality of points thus touched, and based on the scale factor thus changed. As a result, the smartphone 1 can enlarge or reduce the display image 60 displayed on the touch-screen display 2, without performing complicated operations.

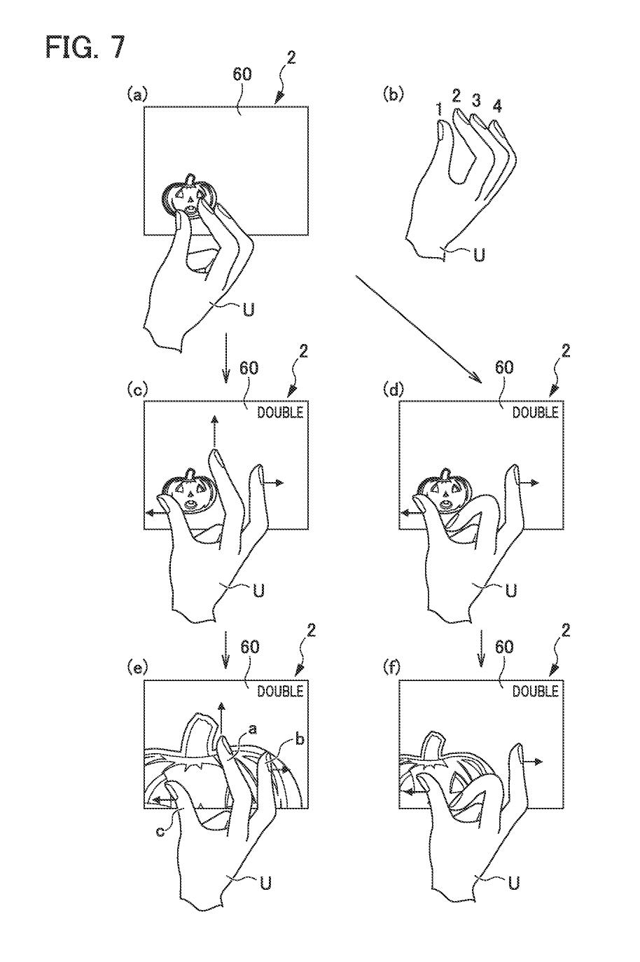

FIGS. 7(a) to 7(f) are screen transition diagrams showing processing of changing a scale factor for enlarging an image displayed on the touch-screen display 2.

The controller 10 changes the scale factor for enlarging or reducing the display image 60, based on the number of the plurality of points, the touch to which was firstly detected on the touch-screen display 2. In the present embodiment, the original scale factor of the display image 60 (before enlargement or reduction) is 1.

For example, as shown in FIG. 7(b), the controller 10 sets scale factors for enlargement for numbers of touches, respectively, in advance. In the example shown in FIG. 7(b), in a case in which n points are touched, the scale factor for enlargement is set to 2^{n 2}. In other words, the scale factor for enlargement is set as follows. In a case in which two points are touched, the scale factor is set to 2²⁻²=2⁰=1. In a case in which three points are touched, the scale factor is set to 2^{3 2}=2¹=2. In a case in which four points are touched, the scale factor is set to 2⁴⁻²=2²=4. In a case in which five points are touched, the scale factor is set to 2⁵⁻²=2³=8.

As shown in FIG. 7(a), when the controller 10 firstly detects a touch to three points on the touch-screen display 2, the controller 10 changes the scale factor for enlargement or reduction of the display image 60 to 2¹=2 (double) or ½ (half). As shown in FIG. 7(c), the controller 10 enlarges or reduces the display image 60, based on a relative distance between two of the three points (for example, between two points touched by the finger a and the finger b, respectively), and based on the scale factor thus changed (2 (double) or ½ (half)). For example, as shown in FIG. 7(d), when the distance between the two points is increased (by pinch-out), the controller 10 enlarges the display image 60, based on the distance of the pinch-out, and based on the scale factor of 2 (double). Alternatively, when the distance between the two points is decreased (by a pinch-in), the controller 10 reduces the display image 60 by the scale factor of ½ (half). In this way, the smartphone 1 changes the scale factor, based on the number of a plurality of points, the touch to which was firstly detected. Therefore, the scale factor can be set by simple operations.

After detecting a touch to a plurality of points on the touch-screen display 2, the controller 10 changes the scale factor for enlarging or reducing the display image 60 displayed on the touch-screen display 2, and maintains the scale factor thus changed, based on the number of the plurality of points, the touch to which was firstly detected, regardless of whether the number of the plurality of touched points is increased or decreased.

For example, as shown in FIGS. 7(e) and 7(f), after the scale factor for enlargement or reduction was changed to 2 (double), even in a case in which the number of points touched on the touch-screen display 2 is decreased, the controller 10 enlarges or reduces the display image 60, based on a relative distance between two points (for example, between two points touched by the finger a and the finger b, respectively), and based on the scale factor (2 (double)) thus changed.

Here, in a case of a device including a large-size touch-screen display, a plurality of gestures (by a pinch-in or a pinch-out) are required for enlarging or reducing a display image displayed on the touch-screen display. The smartphone 1 described above changes the scale factor for enlarging or reducing an image displayed on the touch-screen display 2, based on detection of the number of a plurality of points touched. As a result, the smartphone 1 can enlarge or reduce the display image 60 displayed on the touch-screen display 2 by simple operations, and thus can improve the operability for enlarging or reducing an image.

In place of the processing described above, when the controller 10 firstly detects a touch to three points on the touch-screen display 2, the controller 10 may change the scale factor for enlarging or reducing the display image 60 to (2⁰=1)+(2¹=2)=3 (triple) or ⅓ (one third).

In this case, the controller 10 enlarges or reduces the display image 60, based on a relative distance between two of the three points (for example, between two points touched by the finger a and the finger b, respectively), and based on the scale factor thus changed (3 (triple) or ⅓ (one third)).

In a case in which the controller 10 detects a touch to a second plurality of points within a predetermined period since the touch to the touch-screen display 2 was released, the controller 10 displays the display image 60 by enlarging or reducing the display image 60, based on a changed scale factor for enlarging or reducing the display image 60 (for example, 4 (quadruple) or ¼ (one fourth). As a result, with the smartphone 1, since the user does not have to continue touching the touch-screen display, the operability for enlarging or reducing an image can be improved.

As shown in FIGS. 7(c) to 7(f), the controller 10 may display, on the touch-screen display 2, the scale factor for enlarging or reducing the display image 60. This allows the user to easily understand how much the image is enlarged or reduced, and this is therefore effective in particular in a case in which the scale factor is significantly changed.

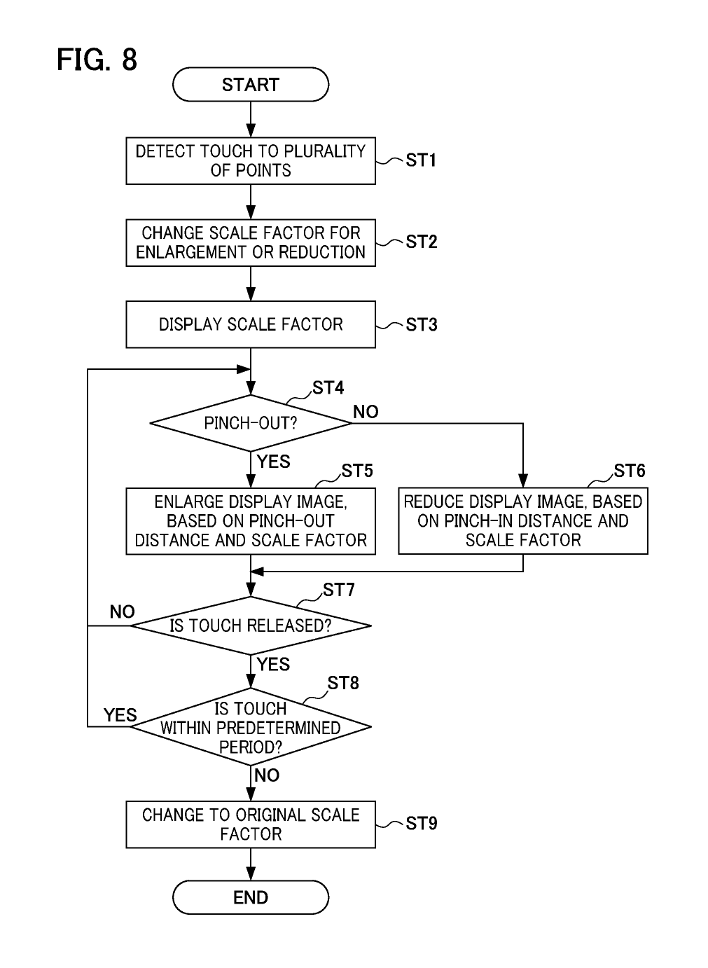

Next, descriptions are provided for a flow of processing of enlarging an image displayed on the touch-screen display 2, with reference to a flowchart shown in FIG. 8.

In Step ST1, the controller 10 detects a touch to a plurality of points on the touch-screen display 2.

In Step ST2, the controller 10 changes the scale factor for enlarging or reducing the display image 60, based on the number of the plurality of points, the touch to which was firstly detected on the touch-screen display 2.

In Step ST3, the controller 10 displays, on the touch-screen display 2, the scale factor for enlarging or reducing the display image 60.

In Step ST4, the controller 10 determines whether a pinch-in or a pinch-out was performed after touching the plurality of points. In a case in which the pinch-out was performed, the controller 10 advances the processing to Step ST5; and in a case in which the pinch-in was performed, the controller 10 advances the processing to Step ST6.

In Step ST5, the controller 10 enlarges the display image 60, based on a movement distance of the pinch-out, and based on the scale factor thus changed. In Step ST6, the controller 10 reduces the display image 60, based on a movement distance of the pinch-in, and based on the scale factor thus changed.

In Step ST7, the controller 10 determines whether the touch to the touch-screen display 2 was released. In a case in which the touch was released, the controller 10 advances the processing to Step ST8; and in a case in which the touch was maintained, the controller 10 advances the processing to Step ST4.

In Step ST8, after the touch was released, the controller 10 determines whether another touch was detected within a predetermined period. In a case in which the predetermined period has elapsed, the controller 10 advances the processing to Step ST4; and in a case in which the predetermined period has not elapsed, the controller 10 advances the processing to Step ST9.

In Step ST9, the controller 10 changes the scale factor for enlarging or reducing the display image 60 on the touch-screen display 2 to the original scale factor, and terminates the processing shown in the present flowchart.

As described above, the smartphone 1 can enlarge or reduce the display image 60 displayed on the touch-screen display 2 by simple operations, and thus can improve the operability for enlarging or reducing an image.

The present invention is applied not only to enlargement or reduction of a display image as described above, but can also be used for adjusting a zoom factor of the camera 12 or the camera 13, adjusting a sound volume of applications such as a multimedia player, etc.

A part or all of the programs stored in the storage 9 as described in FIG. 5 may be downloaded from other devices via wireless communication by the communication unit 6. A part or all of the programs stored in the storage 9 as described in FIG. 5 may be stored in a storage medium that is readable by a reader included in the storage 9. A part or all of the programs stored in the storage 9 as described in FIG. 5 may be stored in a storage medium such as a CD, a DVD or a Blu-ray that is readable by a reader connected to the external interface 14.

The configuration of the smartphone 1 shown in FIG. 5 is an example, and may be altered as appropriate within the scope without departing from the spirit of the present invention. For example, the number and type of the button(s) 3 are not limited to the example shown in FIG. 5. For example, the smartphone 1 may include buttons with a numeric keypad layout or a QWERTY keyboard layout, in place of the buttons 3A to 3C, as buttons for operations regarding screens. The smartphone 1 may include only a single button and may not include any button, for operations regarding screens. In the example shown in FIG. 5, the smartphone 1 includes two cameras, but the smartphone 1 may include only a single camera, and may not include any camera. In the example shown in FIG. 5, the smartphone 1 includes three types of sensors for detecting the position and posture, but the smartphone 1 may not include some of these sensors, and may include other types of sensors for detecting the position and posture. The illuminance sensor 4 and the proximity sensor 5 may be configured as a single sensor instead of separate sensors.

A characteristic embodiment has been described for the purpose of completely and clearly disclosing the present invention. However, the invention according to the attached claims should not be limited to the above embodiment, and the invention should be configured to embody all modifications and substitutable configurations that can be created by a person skilled in the art within the scope of the basic matter described herein.

For example, each program shown in FIG. 5 may be divided into a plurality of modules, and may be coupled with other programs.

In the above embodiment, the smartphone has been described as an example of a device including a touch-screen display, but the device according to the attached claims is not limited to a smartphone. For example, the device according to the attached claims may be a portable electronic device such as a portable phone, a portable personal computer, a digital camera, a media player, an electronic book reader, a navigator or a gaming machine. The device according to the attached claims may be an electronic device of a standing type such as a desktop PC or a television receiver.

1. A device comprising:
a touch-screen display that detects a touch to a plurality of points; and
a controller that changes a scale factor for enlarging or reducing an image displayed on the touch-screen display in response to the touch to the plurality of points, and displays the image by enlarging or reducing the image, based on the scale factor thus changed.

2. The device according to claim 1, wherein the controller enlarges or reduces the image, based on a relative distance between two points among the plurality of points thus touched.

3. The device according to claim 1, wherein the controller changes the scale factor for enlarging or reducing the image, based on a number of the plurality of points, the touch to which was detected.

4. The device according to claim 3, wherein the controller changes the scale factor for enlarging or reducing the image, based on the number of the plurality of points, the touch to which was detected, regardless of whether the number of the plurality of points is increased or decreased after detecting the touch to the plurality of points.

5. The device according to claim 3, wherein, in a case in which a touch to a second plurality of points is detected within a predetermined period since the touch to the plurality of points was released, the controller displays the image by enlarging or reducing the image, based on the scale factor thus changed.

6. The device according to claims 1, wherein the controller displays, on the touch-screen display, the scale factor for enlarging or reducing the image.

7. A method for enlarging or reducing an image displayed on a touch-screen display in a device including the touch-screen display, the method comprising the steps of:
detecting a touch to a plurality of points on the touch-screen display by a controller provided to the device;
changing a scale factor for enlarging or reducing an image displayed on the touch-screen display, in response to detecting the touch to the plurality of points, by the controller; and
enlarging or reducing the image, based on the scale factor.

8. A computer-readable recording medium that stores a program for enlarging or reducing an image displayed on a touch-screen display in a device including the touch-screen display, the program causing the device to execute the steps of:
detecting a touch to a plurality of points on the touch-screen display
setting a scale factor for enlarging or reducing an image displayed on the touch-screen display, in response to detecting the touch to the plurality of points; and
enlarging or reducing the image, based on the scale factor.
